(19) United States
(12) Patent Application Publication
(10) Pub. No.: US 2015/0058254 A1
(43) Pub. Date: Feb. 26, 2015

(54) METHOD AND ARRANGEMENT FOR ELECTRONIC SIGNS

(71) Applicants: Nils Hulth, Uppala (SE); Fredrik Tjerneld, Falun (SE)

(72) Inventors: Nils Hulth, Uppala (SE); Fredrik Tjerneld, Falun (SE)

(73) Assignee: Pricer AB, Sollentuna (SE)

(21) Appl. No.: 14/363,733

(22) PCT Filed: Dec. 8, 2011
(86) PCT No.: PCT/SE2011/051486

§ 371 Date: Sep. 12, 2014

(51) Int. Cl. G06Q 30/02

(52) U.S. Cl. CPC G06Q 30/0282
USPC 705/347

(57) ABSTRACT

The present invention relates to an electronic sign, a system and a method in the system that enables a customer to transmit a feedback related to a product, a product group, a product category, a brand, a store or information associated with the electronic sign. The system comprising displaying means in the electronic sign configured to present a code on the electronic sign, where the code is associated with the electronic sign. Reading means in a mobile terminal is configured to read the code and download user interaction content to the mobile terminal using the code. Feedback means in the mobile terminal is configured to receive a feedback from the customer and transmit the feedback to the server, the feedback being related to the user interaction content and the product, the product group, the product category, the brand, the store or the information. Receiving means in the electronic sign is configured to receive the feedback from the server and the presenting means being further configured to display the feedback on the electronic sign.

### TECHNICAL FIELD

The present invention relates to a method and arrangements to enable a customer to transmit a feedback related to information on an electronic sign

### BACKGROUND

ESLs, Electronic Shelf Labels, are generally electronic pricing and information labels that replace old paper labels, previously used in stores. Price and other information on the ESLs can be wirelessly changed from a computer. The price changes are done in the store's Price Controlling Application (PCA) system. The PCA contains a database which stores information about items in the store, e. g. product name, package size, and current price. The PCA system controls the actual price of an item and provides an ESL-system, to which the ESLs are connected, with updating information whenever the price is changed.

The ESL-system generally comprises software installed on an ESL-server, a hardware infrastructure and ESLs. The hardware infrastructure commonly comprises base stations, transceivers and cables. The ESLs are mounted with their items in the store, e.g. on the shelf-edges. Transceivers are normally mounted in the ceiling and base stations normally on a wall. A predetermined number of transceivers are connected to a base station, which is connected to the ESL-server. The ESL-server is connected to the PCA, often via the same network. There are also other types of ESL-systems which comprise fewer parts. One example is a system comprising only an ESL-server and a single transmitter or Access Point. The transmitter or Access Point may be wirelessly connected to the ESL-server.

A customer review may be an evaluation of a product. In addition to a critical evaluation, the reviewer may assign the product a rating to indicate its relative merit. Today customer can write customer reviews for products in a store using an Internet connected computer or a smart phone. The customer then first has to find the product on the Internet and also a forum for writing the customer review. Today there is therefore no simple solution which makes it possible for customers in a store to review products in the store.

There is therefore a need for an improved solution for which makes it possible for customer to review and read reviews of products in the store, a solution that solves or at least mitigates at least one of the above mentioned problems.

### SUMMARY

An object of the present invention is thus to provide methods and arrangements for enabling a customer to transmit a feedback related to a product, a product group, a product category, a brand or a store associated with the electronic sign.

According to a first aspect, the present invention relates to a system configured to enable a customer to transmit a feedback related to a product, a product group, a product category, a brand, a store or information associated with an electronic sign.

The system comprising: presenting means in the electronic sign configured to present a code on the electronic sign, where the code is associated with the electronic sign. The system further comprises reading means in a mobile terminal configured to read said code and to cause, when said code is read, a feedback related to the product, said product group, said product category, said brand, the store or the information to be transmitted from the mobile terminal. Receiving means in the electronic sign is configured to receive the feedback and the presenting means being further configured to display the feedback on the electronic sign.

According to a second aspect, the present invention relates to a method in a system enabling a customer to transmit a feedback related to a product, a product group, a product category, a brand, a store or information associated with an electronic sign.

The method comprising the steps of: presenting a code associated with the electronic sign;

reading using a mobile terminal the code, wherein reading the code causes a feedback related to the product, the product group, the product category, the brand,

the store or the information to be transmitted from the mobile terminal; receiving in the electronic sign the feedback; and displaying the feedback on the electronic sign.

According to a third aspect, the present invention relates to an electronic sign configured to enable the customer to transmit the feedback related to the product, the product group, the product category, the brand, the store or the information associated with the electronic sign. The electronic sign comprises presenting means in the electronic sign configured to present the code on the electronic sign, where the code is associated with the electronic sign. Receiving means in the electronic sign is configured to receive the feedback from a customer, the feedback being related to user interaction content associated with the code, that allow the creation of user-generated content, and to the product, the product group, the product category, the brand, the store or the information. Displaying means in the electronic sign being further configured to display the feedback on the electronic sign.

### BRIEF DESCRIPTION OF THE DRAWINGS

The invention is described in more detail with reference to enclosed drawings, wherein:

FIG. 1 illustrates schematically a system according to an exemplary embodiment of the present invention.

FIG. 2 illustrates a flow chart according to an exemplary embodiment of the present invention.

### DETAILED DESCRIPTION

In the following description, for purposes of explanation and not limitation, specific details are set forth, such as particular sequences of steps, signaling protocols and device configurations in order to provide a thorough understanding of the present invention. It will be apparent to one skilled in the art that the present invention may be carried out in other embodiments that depart from these specific details.

Moreover, those skilled in the art will appreciate that functions and means explained herein below may be implemented using software functioning in conjunction with a programmed microprocessor or general purpose computer, and/or using an application specific integrated circuit (ASIC). It will also be appreciated that while the current invention is primarily described in the form of methods and arrangements, the invention may also be embodied in a computer program product as well as a system comprising a computer processor and a memory coupled to the processor, wherein the memory is encoded with one or more programs that may perform the functions disclosed herein.

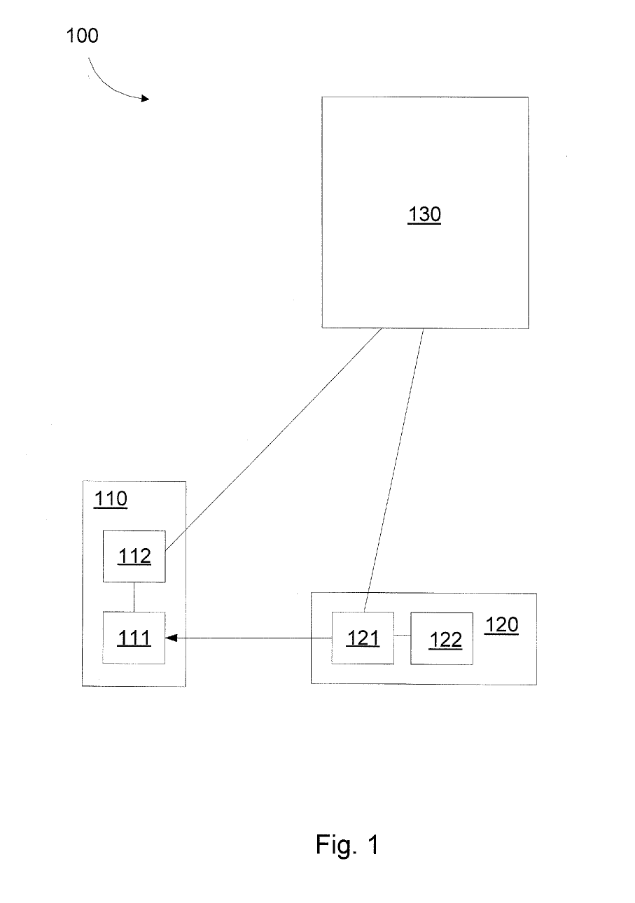

FIG. 1 shows a system 100 according to an exemplary embodiment of the present invention. The system 100 comprises a mobile terminal 120, an electronic sign 110 and a server 130. The electronic sign 110 may be an electronic shelf label or another type of electronic sign 110 placed at other locations. In case the electronic sign 110 is an electronic shelf label the electronic shelf label may display a price and other information about a product associated with the electronic sign 110. The electronic sign 110 may for instance be placed close to the entrance of the store or near a group of products from a specific brand. The electronic sign 110 may be associated with a specific product, brand, product group, product category, brand or store. The electronic sign 110 may be large or small and the size may be adapted to the purpose and position of the electronic sign 110.

The electronic sign 110 comprises presenting means 111 configured to present a code on the electronic sign 110, where the code is associated with the electronic sign 110. The code may also in exemplary embodiment of the present invention be associated with the product, the product group, the product category, the brand, the store or the information associated with an electronic sign 110.

In an exemplary embodiment of the present invention the presenting means 111 is configured to present a QR-code, Quick Response code. A QR code is a type of matrix barcode or two-dimensional code. An advantage with QR-codes is its fast readability and comparatively large storage capacity. The information encoded in the QR-code can be made up of any kind of data, e.g., binary, alphanumeric, or Kanji symbols.

In another exemplary embodiment of the system 100 the code is displayed in association with the electronic sign 110. The code may for instance be displayed on a label near the electronic sign 110. The code may also be preprinted on the electronic sign 110.

The mobile terminal 120 may be of any type, having reading means 121 configured to read the code from the electronic sign 110. The mobile terminal 120 is preferably a mobile phone having reading means 121 configured to read the QR-code. The reading means 121 may be an application running on the mobile terminal 120.

The reading means 121 may be part of a built in application or a third party application. The reading means 121 may also be part of a loyalty application for a specific store. The reading means 121 in the mobile terminal may however be of many different types e.g. an OCR- or a NFC, Near Field Communication, reader. The code may also be a bar code or a RFID-code. The reading means 121 may also be configured for being able to read bar codes and RFID.

The code may be a URL or any combination of characters that identifies the product, the product group, the product category, the brand, the store or the information. The reading means 121 may also be configured to receive the code that is manually entered by the customer. The code may also be data that can that can be used by the reading means 120 and/or an application in the mobile terminal 120 to identify the product, the product group, the product category, the brand, the store or the information associated with the electronic sign 110.

In an exemplary embodiment of the present invention the reading means 120 is configured to, when the code is read by the reading means 120, to cause a feedback related the product, the product group, the product category, the brand, the store or the information to be transmitted from the mobile terminal 120 to the server 130.

In a further exemplary embodiment of the present invention the code is any combination of characters and a feedback related the product, the product group, the product category, the brand, the store or the information can be transmitted from the mobile terminal 120 to the server 130 by sending an SMS containing the code.

In an exemplary embodiment of the present invention the feedback may be a Facebook like or an indication that the product group, the product category, the brand, the store or the information is liked or recommended by the customer.

In yet another exemplary embodiment of the present invention the feedback may be an indication that the customer has been at the position or near the position for the product group, the product category, the brand, the store or the information. The indication may in an exemplary embodiment be a Facebook Check In.

In another exemplary embodiment of the present invention the reading means 121 is further configured to download user interaction content that allows the creation of user-generated content, to the mobile terminal 120 using the code.

In an exemplary embodiment of the present invention the user interaction content is social media content such as Facebook, Twitter or Google+. The user interaction content may also be content related to Groupon or other applications for customer rebates. The content may however be other types of content, e.g. Web content that is the textual, visual or aural content that is encountered as part of the user experience on websites. The social media may be web-based content which turn communication into an interactive dialogue and which allow the creation and exchange of user-generated content. The content may also be Web content that is specially adapted for mobile terminals.

The reading means 121 is configured to download the user interaction content from the server 130 using the code. The server 130 identifies the user interaction content that is associated with the code and transmits the user interaction content to the reading means 121. In one exemplary embodiment the code is an URL that the reading means 121 uses to contact the server 130 which in turn responds with the user interaction content associated with the URL.

In another exemplary embodiment of the present invention the reading means 121 is further configured to transmit the code from the mobile terminal 120 to an intermediate server 140 (not shown). The intermediate server 140 is configured to find in the intermediate server 140 a meta data associated with the code and transmit the meta data to the reading means 121. The meta data may be a URL. In this exemplary embodiment the reading means 121 is further configured to use the meta data when downloading the user interaction content to the mobile terminal 120.

In an exemplary embodiment the meta data may be a URL adapted to a specific type of mobile terminal 120 and/or specific application running on the mobile terminal 120. An advantage with this exemplary embodiment is that in case a type of mobile terminal and/or specific application requires a different URL format the intermediate server 140 can transmit the correct URL format depending on the type of mobile terminal 120 and/or specific application. For example, launching a specific application on a mobile terminal might require a different URL on one brand of mobile terminal vs another brand of mobile terminal.

In an exemplary embodiment of the present invention the code is a short URL and the reading means 121 is further configured to make the mobile terminal 120 use the short URL to contact to the intermediate server 140. The intermediate server 140 is configured to find in the intermediate server 140 a new URL that corresponds to the short URL. In this exemplary embodiment the reading means is further configured to use the URL when downloading the user interaction content to the mobile terminal 120. Presenting a short URL associated with the electronic sign 110 has the advantage that the short URL does not take up so much space on and/or memory in the electronic sign.

The reading means 121 may also be configured to allow the customer to choose which user interaction content that should be downloaded to the mobile terminal 120. The reading means 121 may for instance be configured to allow the customer to choose to download content from Facebook, Twitter or Google+.

In yet another exemplary embodiment of the present invention the code is any combination of characters which is recognised by an application on the mobile terminal 120. The application may for instance be a native social media client, a loyalty application, a price comparison application or a review application or the like. In this exemplary embodiment the application is part of the reading means 121 and the reading means 121 is further configured to use the data when downloading the user interaction content to the mobile terminal 120. The reading means 121 may also be configured to retrieve the user interaction content locally from the mobile terminal 120 using the code.

In an exemplary embodiment of the system 100 according to the present invention the the reading means 121 is further configured to transmit an identity and other related information such as for instance a position of the customer to the server 130. The identity may for instance be retrieved from the mobile terminal 120 or from the customer.

In yet another exemplary embodiment , the mobile terminal 120 comprises a feedback means 122 configured to receive a feedback from a customer and transmit the feedback to the server 130, where the feedback being related to the user interaction content and the product, product group, product category, brand or store.

In one exemplary embodiment of the present invention the user interaction content is social media content such as Facebook content, for instance a Facebook page or a Facebook group associated with the product, product group, product category, brand or store. In this exemplary embodiment the feedback means 122 is configured to allow the customer press a Facebook like button and thereby indicate that the customer likes the product, product group, product category, brand or store associated with the Facebook page, Facebook group or other Facebook content. The feedback means 122 is further configured to transmit the feedback to the server 130.

In yet another exemplary embodiment of the present invention the user interaction content is content related to an auction for the product associated with the electronic sign 110. In this exemplary embodiment the feedback means 122 is configured to allow the customer to place a bid on the product associated with the electronic sign 110. The feedback means 122 is further configured to transmit the bid to the server 130.

In another exemplary embodiment of the present invention the user interaction may be Web content associated with the product, the product group, the product category, the brand, the store or the information, which allows the customer to give feedback, rate or express opinion about the product, the product group, the product category, the brand, the store or the information.

The identity of the customer may be known to the server 130. In an exemplary embodiment of the system 100 according to the present invention the feedback means 122 is further configured to transmit an identity and other related information such as for instance position of the customer to the server 130. The identity may for instance be retrieved from the mobile terminal or from the customer.

The code may also contain an identity of the electronic sign 110 and or information in which store the electronic sign 110 is located. This information may be used by the the server 130 and/or the intermediate server 140 and/or a system server 150 (not shown) in order to find the electronic sign 110 from which the feedback was transmitted. The system server may 150 handle the electronic sign 110 in the store.

The system server 150 may be placed in the store or in another location. In an exemplary embodiment the system server 150 is connected directly to the server 130. In another exemplary embodiment is the system server 150 connected to the intermediate server 140 and the intermediate server 140 connected to the server 130.

The electronic sign 110 further comprises receiving means 112 configured to receive the feedback from the server 130. In the exemplary embodiment where the feedback received from the customer was that the customer had pressed a Facebook like button the feedback received is information that a customer has liked, who has liked, how many that has liked, the product, the product group, the product category, the brand, the store or the information associated with the electronic sign 110. The receiving means 112 may be further configured to receive information about the product, the product group, the product category, the brand, the store or the information that was last liked and/or where the product, the product group, the product category, the brand, the store or the information was liked.

In another exemplary embodiment of the present invention the feedback is first transmitted from the server 130 to the intermediate server 140. The intermediate server 140 and/or the server 130 may store information about the identity of the customer which has given the feedback. The intermediate server 140 and/or the server 130 may also store information about when and at which location the feedback was given. The intermediate server 140 and/or the server 130 may further store other information related to the customer and the product, the product group, the product category, the brand, the store or the information associated with the electronic sign 110. In another exemplary embodiment of the present invention the feedback is transmitted to one or several other servers (not shown) in the system 100. This server may store information about the identity of the customer which has given the feedback and information about when and at which location the feedback was given and other information related to the customer and the product, the product group, the product category, the brand, the store or the information associated with the electronic sign 110

In another exemplary embodiment of the present invention the the system server 150 is configured to first receive the feedback and then transmit the feedback to the electronic sign 110. The system server 150 may receive the feedback from the server 130 or from the intermediate server 140. The intermediate server 140 or the server 130 may be further configured to notify the system server 150 that there is new feedback related one of the electronic signs 120 associated with the system server 150.

The receiving means 112 may be configured to receive the feedback from the system server 150. In another exemplary embodiment is the receiving means 112 configured to receive the feedback at scheduled intervals to save battery and/or communication resources.

The presenting means 111 in the electronic sign 110 is further configured to display the feedback on the electronic sign 110. In an exemplary embodiment of the present invention where the user interaction content is Facebook content, the presenting means 111 may be configured to display that a customer has liked the product, the product, the product group, the product category, the brand, the store or the information and the number of persons who has liked the product the product, the product group, the product category, the brand, the store or the information, who has liked the product, the product group, the product category, the brand, the store or the information and other information related to the user interaction content the product group, the product category, the brand, the store or the information associated with the electronic sign 110. The presenting means 111 may be further configured to display comments and/or a rating that the customer has written or given about the product, the product group, the product category, the brand, the store or the information.

In another exemplary embodiment of the system 100 the electronic sign 110 may also display information about which other products the customer has given feedback about.

In yet another exemplary embodiment of the system 100 the receiving means 112 may be further configured to receive information about which product, product group, product category, brand or store that has received the most feed back during a specific period. In this exemplary embodiment the presenting means 111 is further configured to display this information, which product, product group, product category, brand or store that has received the most feed back during a specific period.

In yet another exemplary embodiment of the system 100 the customer may be given a rebate or a gift in case the customer gives feedback or in case a certain number of customers have given feedback about a product, product group, product category, brand or store associated with the electronic sign 110. In this exemplary embodiment the system 100 may be further configured to transmit information to the mobile terminal 120 that the customer has given feedback related to product, product group, product category, brand or store and that the customer should be given a rebate or a gift. This information could for instance be showed to a cashier in the store. In an exemplary embodiment the system server 150 and/or the intermediate server 140 is configured to transmit information to the mobile terminal 120 that the customer has been given a rebate. The receiving means 112 may be further configured to receive information that a customer has been given a rebate and the displaying means 110 may be further configured to display information on the electronic sign 110 that a customer has been given a rebate.

In yet another exemplary embodiment of the system 100 a price displayed on the electronic sign 110 may be reduced in case the customer gives feedback about the product, the product group, the product category, the brand, the store or the information associated with the electronic sign 110. The feedback may in an exemplary embodiment be an indication that the customer has been at or near the position for the product, the product group, the product category, the brand, the store or the information. In an exemplary embodiment is the feedback that the customer has checked in using Facebook at or near the product, the product group, the product category, the brand, the store or the information associated with the electronic sign 110.

In this exemplary embodiment the system server 150, the intermediate server 140 or another server is configured to transmit information to the electronic sign 110 that the price has been reduced. The receiving means 112 is further configured to receive information that that the price has been reduced and further configured to display information on the electronic sign 110 that the price has been reduced.

In yet another exemplary embodiment of the system 100 may be used by employees to order the products associated with the electronic sign 110. In this exemplary embodiment an employee may read the code using a mobile terminal 120. The reading means 121 in the mobile terminal are configured to download content to the mobile terminal 120 using the code, where the content is content to place an order of the product. The feedback means 122 in the mobile terminal 120 is configured to receive an order from the employee and transmit the order to the server 130, the order being related to the product, the product group, the product category, the brand, the store or the information and the content related to ordering of the product, the product group, the product category or the brand. The receiving means 112 in the electronic sign 110 is further configured to receive the information that the product has been order and/or for instance estimated delivery date from the from the server 130. The presenting means 111 is further configured to display information that the product has been order and/or for instance estimated delivery date on the electronic sign 110.

In exemplary embodiment of the system 100, the presenting means 111 is configured to display information related to the feedback on the electronic sign 110. In an exemplary embodiment of the present invention where the user interaction content is Facebook content, the presenting means 111 may be configured to display that a customer has liked the product, the product, the product group, the product category, the brand, the store or the information by for instance displaying a specific symbol.

In yet another exemplary embodiment of the system 100 may be used by customers to buy or order the products associated with the electronic sign 110. In this exemplary embodiment information on the electronic sign 110 may indicate that the product associated with the electronic sign 110 is out of stock. In this exemplary embodiment a customer may read the code using the mobile terminal 120. The reading means 121 in the mobile terminal 120 is configured to download content to the mobile terminal 120 using the code, where the content is content to for buying or placing an order for the product. The feedback means 122 in the mobile terminal 120 is configured to receive an order from the customer and transmit the order to the server 130, the order being related the content for ordering of the product, the product group, the product category, the brand or the product. The receiving means 112 in the electronic sign 110 is further configured to receive the information that the product has been bought or ordered and/or for instance estimated delivery date, remaining stock, number of customers who have ordered, last order date, estimated delivery date for next order from the from the server 130. The presenting means 111 is further configured to display information that the product has been bought or ordered and/or for instance estimated delivery date remaining stock, number of customers who have ordered, last order date, estimated delivery date for next order on the electronic sign 110.

The present invention also relates to the electronic sign 110 configured to enable the customer to transmit the feedback related to the product, the product group, the product category, the brand, the store or the information associated with the electronic sign 110, The electronic sign 110 comprises presenting means 111 in the electronic sign configured to display the code on the electronic sign 110, where the code is associated with the electronic sign (110). Receiving means 112 in the electronic sign 110 is configured to receive the feedback from a customer, said feedback being related a user interaction content, that allow the creation of user-generated content, and to the product, the product group, the product category, the brand, the store or the information.

Displaying means 111 may be further configured to display the feedback on the electronic sign 110.

The receiving means 112 may be configured to receive the feedback from the server 150. The receiving means 112 is further configured to receive the feedback instantaneously or at scheduled intervals.

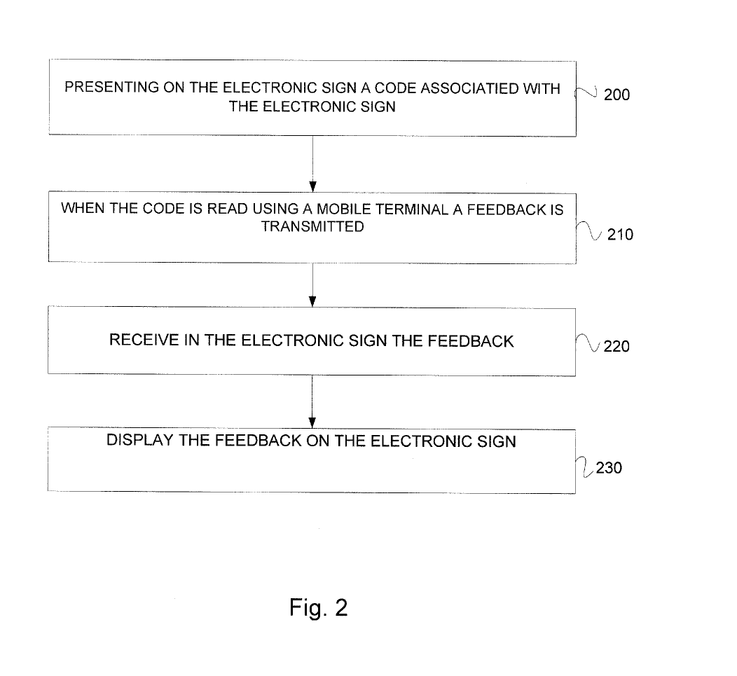

Referring to FIG. 2 there is illustrated a flow chart of a method in a system enabling a customer to transmit the feedback related to a product, product group, product category, brand or store associated with the electronic sign 110. As shown in FIG. 2, the method comprises a first step 200 of presenting the code associated with the electronic sign 110. In the next step 210 is the code read using the mobile terminal 120, wherein reading the code causes a feedback related to the product, the product group, the product category, the brand, the store or the information to be transmitted from the mobile terminal 120. Next, in a step 220, is the feedback received in the electronic sign 110. In step 230 is the feedback displayed on the electronic sign 110.

As previously described the step of reading 210 may further comprises downloading , before transmitting the feedback, a user interaction content, that allow the creation of user-generated content, to the mobile terminal 120 using the code and receiving the feedback from a customer, wherein the feedback being further related to the user interaction content.

While the present invention has been described with respect to particular embodiments (including certain device arrangements and certain orders of steps within various methods), those skilled in the art will recognize that the present invention is not limited to the specific embodiments described and illustrated herein.

Therefore, it is to be understood that this disclosure is only illustrative. Accordingly, it is intended that the invention be limited only by the scope of the claims appended hereto.

1-10. (canceled)

11-18. (canceled)

19. A system that allows a customer to review and read reviews of products in a store, the system comprising:
an electronic sign comprising presenting means configured to present a code on the electronic sign, where the code is associated with the electronic sign and with user interaction content allowing the customer to create feedback related to a product, a product group, a product category, a brand, a store or information associated with said electronic sign;
a mobile terminal comprising:
reading means configured to read said code and to download the user interaction content to the mobile terminal using the code, or to retrieve the user interaction content locally from the mobile terminal using the code;
feedback means configured to receive said feedback from the customer using said user interaction content, and to transmit the feedback to a system server, and
a system server arranged to receive the feedback transmitted from the mobile terminal and to transmit information related to the customer created feedback to the electronic sign in response to the reception of the feedback,
said electronic sign further comprising receiving means configured to receive the related feedback from the system server, the presenting means of the electronic sign further being configured to display the related feedback on the electronic sign.

20. The system according to claim 19, wherein said reading means is further configured to transmit the code from the mobile terminal to an intermediate server, and wherein the intermediate server is configured to find in said intermediate server a meta data associated with said code, the reading means being further configured to use said meta data when downloading said user interaction content or retrieving the user interaction content locally from the mobile terminal.

21. The system according to claim 20, wherein said reading means being further configured to transmit an identity of said customer.

22. The system according to claim 21, wherein said receiving means is further configured to receive the information related to the customer created feedback instantaneously or at scheduled intervals.

23. The system according to claim 22, wherein said user interaction content is Facebook, Twitter or Google+ or content related to an auction, a customer reviews or a rating of the product.

24. The system according to claim 21, wherein said user interaction content is Facebook, Twitter or Google+ or content related to an auction, a customer reviews or a rating of the product.

25. The system according to claim 20, wherein said receiving means is further configured to receive the information related to the customer created feedback instantaneously or at scheduled intervals.

26. The system according to claim 25, wherein said user interaction content is Facebook, Twitter or Google+ or content related to an auction, a customer reviews or a rating of the product.

27. The system according to claim 20, wherein said user interaction content is Facebook, Twitter or Google+ or content related to an auction, a customer reviews or a rating of the product.

28. The system according to claim 19, wherein said reading means being further configured to transmit an identity of said customer.

29. The system according to claim 28, wherein said receiving means is further configured to receive the information related to the customer created feedback instantaneously or at scheduled intervals.

30. The system according to claim 29, wherein said user interaction content is Facebook, Twitter or Google+ or content related to an auction, a customer reviews or a rating of the product.

31. The system according to claim 19, wherein said receiving means is further configured to receive the information related to the customer created feedback instantaneously or at scheduled intervals.

32. The system according to claim 31, wherein said user interaction content is Facebook, Twitter or Google+ or content related to an auction, a customer reviews or a rating of the product.

33. The system according to claim 19, wherein said user interaction content is Facebook, Twitter or Google+ or content related to an auction, a customer reviews or a rating of the product.
